(19) United States
(12) Patent Application Publication
(10) Pub. No.: US 2026/0247417 A1
(43) Pub. Date: Aug. 20, 2026

(54) COORDINATION IN RADIO ACCESS NETWORK

(71) Applicant: Nokia Technologies Oy, Espoo (FI)

(72) Inventors: Bighnaraj PANIGRAHI, Bangalore (IN); Ugur Baran ELMALI, Munich (DE); Philippe GODIN, Massy (FR); Esa Mikael MALKAMÄKI, Espoo (FI); Chitradeep MAJUMDAR, Bangalore (IN)

(21) Appl. No.: 19/162,198

(22) PCT Filed: Apr. 25, 2024
(86) PCT No.: PCT/FI2024/050195

§ 371 Date: Sep. 4, 2025

(30) Foreign Application Priority Data
May 2, 2023 (IN) 202311031236

(51) Int. Cl. H04W 72/30; H04W 76/40

(52) U.S. Cl. CPC H04W 72/30; H04W 76/40

(57) ABSTRACT

Embodiments of the present disclosure relate to devices, methods, apparatuses and computer readable storage media of coordination in RAN. The method comprises receiving, from at least one second network device managing control plane data for at least one core network of a first operator, at least one bearer setup or modification request comprising identification information of a broadcast service, and an indicator of whether sharing a tunnel with at least one other core network of a different operator is allowed; selecting, based at least on the indicator, at least one target tunnel for communicating the broadcast service with the at least one core network; and transmitting, to the at least one second network device, at least one bearer setup or modification response comprising identification information of the at least one target tunnel.

### FIELDS

Various example embodiments of the present disclosure generally relate to the field of telecommunication and in particular, to methods, devices, apparatuses and computer readable storage medium for coordination in radio access network (RAN).

### BACKGROUND

In a 5G Multi-Operator Core Network (5G MOCN), multiple CNs may be connected to the same NG-RAN. When the same broadcast content is to be delivered to multiple CNs, the application function (AF) sets up multiple Multicast and Broadcast Service (MBS) sessions towards those CNs, and each CN delivers the same content towards the same shared NG-RAN node. Therefore, for a broadcast MBS Session, the consumed radio resources will be (N-1) times more than needed, where N is the number of CNs involved.

To avoid consuming more radio resources than needed, the NG-RAN node may need to identify that the same content is delivered by broadcast MBS sessions from different CNs, and which Public Land Mobile Network (PLMN) is used to broadcast the MBS session data. The NG-RAN node may also concern whether and how to enable the UE to receive the broadcast content from the broadcast PLMN when the UE camps on cells of other PLMNs. Therefore, coordination operations are required in such shared NG-RAN node.

### SUMMARY

In a first aspect of the present disclosure, there is provided a first network device managing user plane data. The first network device comprises at least one processor; and at least one memory storing instructions that, when executed by the at least one processor, cause the first network device at least to: receive, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed; select or create, based at least on the indicator, at least one target tunnel for communicating the broadcast service with the at least one core network; and transmit, to the at least one second network device, at least one broadcast bearer setup or modification response comprising identification information of the at least one target tunnel.
In a second aspect of the present disclosure, there is provided a second network device managing control plane data for at least one core network. The second network device comprises at least one processor; and at least one memory storing instructions that, when executed by the at least one processor, cause the second network device at least to: receive, from at least one entity of at least one core network, at least one broadcast service setup or modification request for a broadcast service; transmit, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network; and receive, from the first network device, at least one bearer setup or modification response comprising identification information of the at least one target tunnel for communicating the broadcast service with the at least one core network.
In a third aspect of the present disclosure, there is provided a method. The method comprises: receiving, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed; selecting or creating, based at least on the indicator, at least one target tunnel for communicating the broadcast service with the at least one core network; and transmitting, to the at least one second network device, at least one bearer setup or modification response comprising identification information of the at least one target tunnel.
In a fourth aspect of the present disclosure, there is provided a method. The method comprises: receiving, from at least one entity of at least one core network, at least one broadcast service setup or modification request for a broadcast service; transmitting, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network; and receiving, from the first network device, at least one bearer setup or modification response comprising identification information of the at least one target tunnel for communicating the broadcast service with the at least one core network.
In a fifth aspect of the present disclosure, there is provided a first apparatus. The first apparatus comprises means for receiving, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed; means for selecting or creating, based at least on the indicator, at least one target tunnel for communicating the broadcast service with the at least one core network; and means for transmitting, to the at least one second network device, at least one bearer setup or modification response comprising identification information of the at least one target tunnel.
In a sixth aspect of the present disclosure, there is provided a second apparatus. The second apparatus comprises means for receiving, from at least one entity of at least one core network, at least one broadcast service setup or modification request for a broadcast service; means for transmitting, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network; and means for receiving, from the first network device, at least one bearer setup or modification response comprising identification information of the at least one target tunnel for communicating the broadcast service with the at least one core network.
In a seventh aspect of the present disclosure, there is provided a computer readable medium. The computer readable medium comprises instructions stored thereon for causing an apparatus to perform at least the method according to the third aspect.
In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example broadcast context setup procedure according to some example embodiments of the present disclosure;

FIG. 3 illustrates a signaling chart illustrating an example coordination process in RAN according to some example embodiments of the present disclosure;

FIG. 4 illustrates a signaling chart illustrating an example coordination process in RAN according to some example embodiments of the present disclosure;

FIG. 5 illustrates a signaling chart illustrating an example coordination process in RAN according to some example embodiments of the present disclosure

FIG. 6 illustrates a flowchart of a method implemented at an apparatus according to some example embodiments of the present disclosure;

FIG. 7 illustrates a flowchart of a method implemented at an apparatus according to some example embodiments of the present disclosure;

FIG. 8 illustrates a flowchart of a method implemented at an apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU). In some deployments options the CU can further split into Centralized Unit Control Plane (CU-CP) and Centralized Unit Control Plane (CU-UP).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

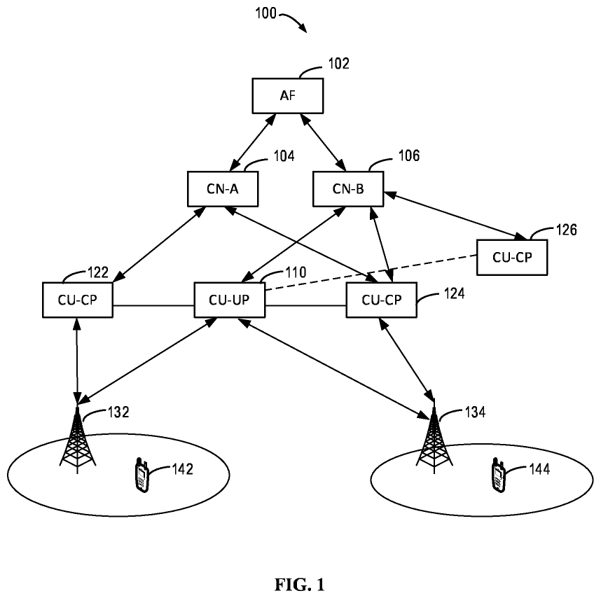

FIG. 1 illustrates an example communication environment 100 in which example embodiments of the present disclosure can be implemented. In the communication environment 100, the AF 102, the CN entity 104 corresponding to operator/PLMN A (which is also referred to CN-A 104), the CN entity 106 corresponding to operator/PLMN B (which is also referred to CN-B 106), RAN nodes (e.g., gNBs) and UE 142 and 144 may communicate with each other.

The AF 102 may set up one or more broadcast service (e.g., MBS session) towards CN-A 104 and CN-B 106. The CN-A 104 and CN-B 106 may deliver the broadcast service towards respective RAN nodes.

In a disaggregated RAN deployment, a RAN node may be split into Centralized Units (CU) and Distributed Units (DU). A CU may either serve multiple CNs, or service only a single CN. In addition, the CU may be further split into a control plane entity (which is also referred to as CU-CP hereinafter) and a user plane entity (which is also referred to as CU-UP hereinafter). In some cases, multiple CU-CPs may share the same CU-UP that would provide the same data to corresponding DUs.

In radio communications, node operations may in be carried out, at least partly, in a central/centralized unit, CU, (e.g., server, host or node) operationally coupled to distributed unit, DU, (e.g., a radio head/node). It is also possible that node operations will be distributed among a plurality of servers, nodes or hosts. It should also be understood that the distribution of work between core network operations and base station operations may vary depending on implementation. Thus, 5G networks architecture may be based on a so-called CU-DU split. One gNB-CU may control several gNB-DUs. In some deployments options the CU can further split into Centralized Unit Control Plane (CU-CP) and Centralized Unit Control Plane (CU-UP). In some embodiments, however, the gNB-DUs (also called DU) may comprise e.g., a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) layer and an internet protocol (IP) layer. Other functional splits are possible too.

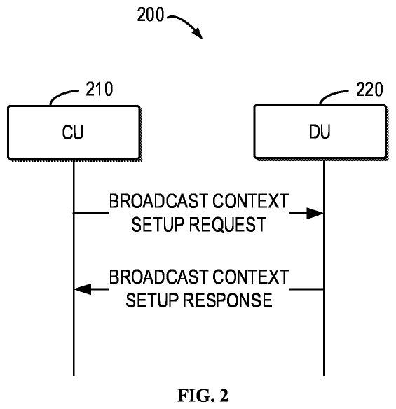

FIG. 2 illustrates an example broadcast context setup procedure 200 according to some example embodiments of the present disclosure. As shown in FIG. 2, a CU 210 may initiate a broadcast context setup procedure by transmitting a broadcast context setup or modification request message (or generally, a request) to a DU 220, after receiving a broadcast service setup or modification request for a broadcast service from the CN. If the DU 200 succeeds to establish the broadcast context, it may reply to the CU 210 with a broadcast bearer setup or modification response message.

In the example of FIG. 1, CU-CP 122 serves only the CN-A 104, CU-CP 124 serves both the CN-A 104 and the CN-B 106, and CU-CP 126 serves only the CN-B 106. In addition, CU-CP 122, CU-CP 124 and CU-CP 126 shares the CU-UP 110. A first gNB may consist of the CU-CP 122, CU-UP 110 and DU 132, and serve the UE 142. A second gNB may consist of the CU-CP 124, CU-UP 110 and DU 134, and serve the UE 144.

In some example embodiments, the same MBS broadcast service may be created by multiple CNs, e.g., CN-A 104 and CN-B 106. Each PLMN may create a separate native identifier for the same service, i.e., temporary mobile group identifier (TMGI). For example, CN-A 104 may identify a broadcast service by TMGI-A, while CN-B 102 may identify the same broadcast service by TMGI-B. TMGI is unique per broadcast session and created separately by each of the PLMNs/CNs for the same shared service. One PLMN may be associated with one CN.

Additional information of the broadcast service may be provided to the RAN nodes, such that the CU-UP 110 may understand that both TMGIs refer to the same broadcast service, and thereby transmitting data only once in the radio interface. For example, the CN-A 104 and CN-B 106 may transmit an identifier of the broadcast service common with at least two core networks, which is called Associated Session Identifier (e.g., source-specific multicast (SSM) IP) address along with the respective TMGI. When the RAN node shared by the CN-A 104 and CN-B 106 receives a request for creation of the broadcast session coming from different CNs via different TMGIs along with the common Associated Session Identifier, the RAN node may understand that those different TMGIs belong to the same service, and therefore the RAN node is able to transmit the data only once in the radio interface by using the same group-common RNTI (G-RNTI). UEs of the sharing PLMNs (e.g., UEs belonging to multiple PLMNs that shares a RAN node) will receive the data (and corresponding PDCCH) for the same service only once that is scrambled via the same G-RNTI.

There may be one or more NG-U tunnels between each CN and the shared RAN node, and one or more F1-U tunnels between different non-shared CUs and the shared DU. In addition, the CU-UP 110 shared by multiple CU-CPs may correspond to a shared NG-U termination. In some example embodiments, the CU-UP 110 may provide the CU-CPs 122 to 126 at E1 setup or configuration update about established shared NG-U terminations, indicated by one or several MBS session IDs.

At establishment of the broadcast bearer context in the CU-UP 110, the CU-CP may request the CU-UP 110 to either apply the available MRB configuration of the shared NG-U termination, or to apply the MRB configuration requested by the CU-CP. The CU-UP 110 may provide the MRB configuration to the CU-CP if the MRB configuration requested by the CU-CP and the available MRB configuration of the shared NG-U termination are different. In the request message from CU-CP to CU-UP, CU-CP 110 may indicate either one of:
apply already available MRB configuration at CU-UP 110,
apply the requested MRB configuration and not the available MRB configuration at CU-UP 110,
apply the available configuration only if same as the requested MRB configuration.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In a case where CN-B 106 starts an MBS broadcast service (e.g., service X) through CU-CP 124 that serves both the CN-A 104 and CN-B 106, CN-B 106 may provide a NG-U tunnel end point within CN-B (e.g., NG-U tunnel created between CN-B 106 and CU-UP 110 for communicating the broadcast data between CN-B 102 and the second gNB. CU-CP 124 configures CU-UP 110 to receive the broadcast data by using the tunnel information provided from CN-B 106.

In such case, afterwards (e.g., after a short while or in parallel) if CN-A 104 starts the same MBS broadcast service (i.e., service X) at the first gNB, then following issues may arise:

If the same NG-U tunnel between CN-B 106 and CU-UP 110 is used (as same service X) also to provide the broadcast data to UE 142 in the first gNB, it may be problematic for operator/PLMN A, as operator/PLMN A may not like its UE 142 (i.e., UEs of CN-A) within the first gNB (i.e., DU 132) to receive data from CN-B 106 in a non-shared gNB, i.e., the second gNB. Note that the first gNB is not shared among different PLMNs/CNs and only serves CN-A 104.

If a separate tunnel is created between CN-A 104 and CU-UP 110 than what was already established, it may not be resource efficient as the same broadcast data is transmitted redundantly in two different tunnels.

Therefore, coordination among the shared CU-UP and CU-CPs that may be shared by multiple CNs are required in order to have a mutual consent NG-U set-up/configuration. According to the example embodiments of the present disclosure, there is provided a coordination mechanism for RAN nodes. With the coordination mechanism, the shared CU-UP can optimize the use of NG-U tunnels towards various CNs by considering tunnel preference of respective CU-CPs. If a CU-CP allows to use a shared tunnel, then a common tunnel may be configured. Otherwise, if a CU-CP does not allow to use a shared tunnel, then a separate tunnel is to be created. In this way, the resource efficiency and network performance for MBS services can be improved.

Example embodiments of the present disclosure will be described in detail below with reference to the accompanying drawings.

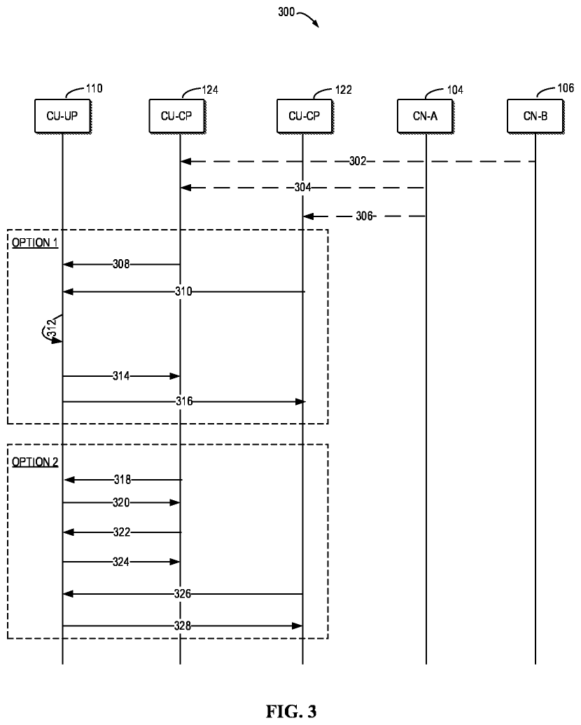

Reference is now made to FIG. 3, which shows a signaling chart 300 for communication according to some example embodiments of the present disclosure. As shown in FIG. 3, the process 300 involves CU-UP 110, CU-CP 122, CU-CP 124, CN-A 104 and CN-B 106. For the purpose of discussion, reference is made to FIG. 1 to describe the signaling chart 300.

In the process 300, CU-CP 122 serves a single CN, i.e., CN-A 104, and CU-CP 124 serves multiple CNs, i.e., both CN-A 104 and CN-B 106. The CN may start a broadcast session by sending a Broadcast Session Setup Request message (e.g., NGAP Broadcast Session Setup Request) to one or more CU-CPs. This request maybe broadcast service setup request or a broadcast service modification request, for example. Hence, accordingly the CU-CPs 122 and 124 may receive either single or multiple broadcast service setup requests.

For example, the CU-CP 124 may receive 302 a Broadcast Session Setup Request message from CN-B 106. The Broadcast Session Setup Request may comprise the TMGI (e.g., TMGI-B) and GTP tunnel ID (e.g., NG-U TNL-B) and optionally other information (e.g., SSM).

In addition, the CU-CP 124 may also receive 304 a Broadcast Session Setup Request message from CN-A 104 comprising TMGI-A, NG-U TNL-A1, and SSM. As CU-CP 124 is shared among multiple CNs, SSM may be provided for identifying broadcast services across CNs.

The CU-CP 122 may receive 306 a Broadcast Session Setup Request message from CN-A 104. For example, the Broadcast Session Setup Request may comprise TMGI-A, NG-U TNL-A2.

Upon receiving the Broadcast Session Setup Request, the CU-CPs may share information related to the broadcast service and tunnel with the CU-UP 110. Such information may be carried in a broadcast bearer setup request (e.g., E1AP Broadcast Bearer Context Setup Request) message or a bearer modification request (e.g., E1AP Broadcast Bearer Context Modification Request) to CU-UP 110.

In some example embodiments, information related to the broadcast service and tunnel may comprise one or more of TMGI, NG-U tunnel ID, tunnel preference information (i.e., towards which CN the CU-UP 110 should create a tunnel), an indicator (e.g., flag) of whether sharing a tunnel with at least one other CN is allowed, which may be called OPEN-or-Not-indicator.

As an example, the indicator may be set to one of the following:
OPEN: OPEN-to-ANY tunnel, i.e., whether the CU-CP is open for a shared NG-U tunnel, even if the CU-CP will work with a non-serving CN (e.g. even if the CU-CP which the tunnel may be shared is associated with a CN that is not served by the CU-CP from which the OPEN-or-not indictor is sent),
Not OPEN: Not OPEN-to-ANY, i.e., the CU-CP does not agree for sharing the NG-U tunnel with a non-serving CN, or
Conditional OPEN: Conditional OPEN-to-ANY, i.e., the CU-CP is not OPEN-to-ANY in general, but in case an existing tunnel with its CN fails, it becomes OPEN-to-ANY.

In some example embodiments, the indicator set to OPEN-to-ANY not only means that the corresponding CU-CP is OPEN to use a shared NG-U tunnel set-up with a non-serving CN. It also indicates that the CU-CP is OPEN to share the NG-U tunnel with another CU-CP which may have a different RAN sharing agreement with multiple CNs. For example, the CU-CP 124 has a RAN sharing agreement with CN-A 104 and CN-B 106, and another CU-CP (not shown) has a RAN sharing agreement with CN-B 106 and CN-C (not shown), in this case, they have different RAN sharing agreements, and both are OPEN to use a shared NG-U tunnel.

Alternatively, in some example embodiments, the indicator of whether sharing a tunnel with at least one other CN is allowed (e.g., the OPEN-or-Not-indicator) may be optionally. For example, in a case where the tunnel preference information is provided, the indicator may or may not be omitted.

The bearer context setup request may be created following any of the below options:

In Option 1, after receiving multiple broadcast session setup requests from multiple serving CNs, the CU-CP 124 transmits 308 a single Bearer Context Setup or Modification Request (e.g., E1 Broadcast Setup Request or E1 Broadcast Modification Request) message to the shared CU-UP 110. The single bearer context setup request message may combine all the collective information, such as, a list of TMGIs, a list of NG-U tunnel IDs, tunnel preference information, and/or the OPEN-or-Not-indicator. The CU-CP 124 may further optionally transmit the Associated Session Identifier (e.g., SSM).

The CU-CP 122 serving the single CN transmits 310 a bearer context setup or modification request comprising a single TMGI, NG-U tunnel ID, and OPEN-or-Not-indicator.

The CU-UP 110 selects 312 one NG-U tunnel among at least one preference options based on the information in respective Bearer Context Setup or Modification Request messages. In particular, if a CU-CP has set the indicator to be “Not OPEN”, the CU-UP 110 may use the tunnel with the corresponding CN in case of the CU-CP serving only single CN, or one among the serving CNs in case of the CU-CP serving multiple CNs.

The CU-UP 110 may then share ID information of the selected NG-U Tunnel with all the CU-CPs associated with the CU-UP 110. As shown, the CU-UP 110 transmits 314, 316 bearer context setup responses (e.g., E1AP Broadcast Bearer Context Setup Responses) comprising the ID information of the selected NG-U Tunnel to the CU-CP 124 and 122, respectively. In case that at least one redundant separate tunnel is created, for example, any CU-CP has set the indicator to be either “Not OPEN” or “Conditional OPEN”, the CU-UP 110 may further include the ID information of the separate tunnel.

In Option 2: the CU-CP 124 shared among CN-A 104 and CN-B 106 may transmit the Bearer Context Setup or Modification Request message for each CN separately. For example, the CU-CP 124 transmits 318, 322 multiple consecutive Bearer Context Setup or Modification Request messages sequentially, for example, in the order in which it has received the broadcast session setup requests from CN-A 104 and CN-B 106) to the CU-UP 110. In this case, each Bearer Context Setup or Modification Request message may include a corresponding TMGI, NG-U tunnel ID, the Associated Session ID, and the OPEN-or-Not-indicator.

Alternatively, in Option 3, the CU-CP 124 also transmits multiple consecutive Bearer Context Setup or Modification Request messages to the shared CU-UP 110, sequentially. However, in this option, the E1 Broadcast Session Setup or Modification Request messages shall not include the SSM information because instead the SSM information has been pre-configured in the CU-UP 110, thereby the CU-UP 110 may correlate the broadcast sessions corresponding to the same broadcast service itself.

Additionally, in Option 2 and Option 3, CU-CP 124 may indicate in the first transmitted request (corresponding to a first CN, e.g., CN-B 106) whether a separate tunnel should be created towards the respective CN. In the subsequent requests, CU-CP 124 may either not include the tunnel ID information or repeat the tunnel ID of the first requested CN. Therefore, lack of tunnel ID information in this message can indicate to CU-UP 110 that no tunnel should be created and the previously set tunnel should be re-used.

If no NG-U tunnel is to be established after this request, i.e., already existing NG-U tunnel is used, then this E1 Broadcast Session Setup Request is only used by the CU-UP 110 to be aware of the shared broadcast session (e.g., by using SSM in Option 2, or pre-configuration in Option 3) and respective TMGIs for future correlations among TMGIs. CU-UP 110 may refrain from including the MRB information normally present in the response message to save signaling overhead.

In Option 2 and Option 3, the CU-CP 122 may also transmit 326 a Bearer Context Setup or Modification Request message comprising a single TMGI, NG-U tunnel ID, and the OPEN-or-Not indicator.

In response, the CU-UP 110 may then share 320, 324, 328 ID information of the selected NG-U Tunnel with all the CU-CPs associated with the CU-UP 110.

In some example embodiments, assuming that the shared NG-U tunnel may be used exclusively for shared CU-CPs (e.g., CU-CP 124 and CU-CP 126) and for the shared broadcast service (e.g., identified by the same SSM), the CU-UP 110 may create a single shared NG-U tunnel for the CU-CP 124 and CU-CP 126). For the CU-CP 122 that is not shared but has a shared broadcast service, a separate NG-U tunnel ID shall be created. For example, the CU-UP 110 may create a separate NG-U tunnel with CN-A 104 for CU-CP 122. Additionally, any other CU-CP that shares the CU-UP 110 and has the same broadcast service (e.g., identified by TMGI-A) may also share the same NG-U tunnel.

Based on information in Bearer Context Setup or Modification Request messages, the CU-UP 110 may either directly join the data distribution (in case of IP multicast towards CN to RAN) only towards the indicated CN(s), or the CU-UP 110 may provide the selected tunnel ID (out of multiple received tunnel IDs) to be used in the response message to all the associated CU-CPs.

Additionally, or alternatively, in some example embodiments, the CU-UP 110 may also provide all the associated CU-CPs with one or more fallback tunnel ID, which is apart from the selected tunnel ID.

When the CU-UP 110 has multiple CN options to create NG-U tunnel with (e.g., no preference was indicated by CU-CPs or CU-UP receives different tunnel preference information from different CU-CPs), the CU UP 110 may select the CN which has CU-CPs that are serving only a single CN, and hence create the NG-U tunnel with it. For, example, in the example of FIG. 1, the CU-UP 110 may co-ordinate to create a tunnel with CN-A 104, as CN-A 104 has non-sharing CU-CP 122.

Alternatively, the shared CU UP 110 may add one or more necessary, redundant NG-U tunnels upon receiving a request from a new CU-CP which tunnel preference is not satisfied.

In case the selected shared NG-U tunnel is failed, for example, disconnected, broke due to congestion, or stopped by the CN, the CU-UP 110 may select an alternate NG-U tunnel from the fallback list of NG-U tunnel IDs. This is valid for the CU-CPs that have set their indicator to be “OPEN” or “Conditional OPEN”. For CU-CPs that have set their indicator to be “Not OPEN” (i.e., not OPEN-to-ANY NG-U tunnel), the CU-UP 110 may continue to create redundant, separate NG-U tunnel to a corresponding CN.

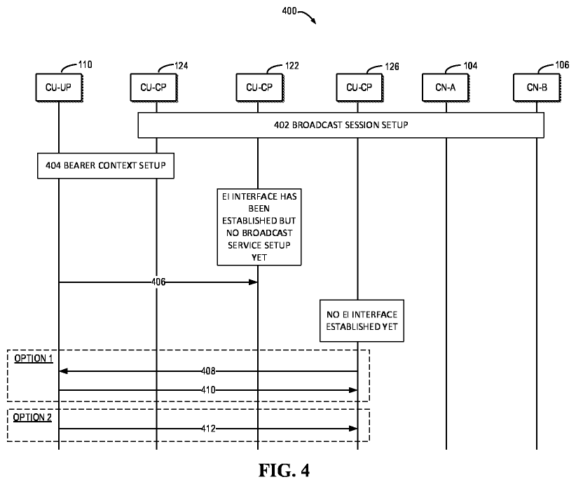

Reference is now made to FIG. 4, which shows a signaling chart 400 for communication according to some example embodiments of the present disclosure. As shown in FIG. 4, the process 400 involves CU-UP 110, CU-CP 122, CU-CP 124, CU-CP 126, CN-A 104 and CN-B 106. For the purpose of discussion, reference is made to FIG. 1 to describe the signaling chart 400.

In process 400, the CN-A 104 and CN-B 106 have setup 402 the broadcast session with CU-CP 124 respectively. The CU-UP 110 has performed 404 the bearer context setup with CU-CP 124.

After the shared CU-UP 110 has received Bearer Context Setup or Modification Request messages from the associated CU-CPs (including single CN connected CU-CP 122 and/or multiple CN connected CU-CP 124), the CU-UP 110 may proactively exchange the collective information (e.g., a list of TMGIs, identification information of the selected/created NG-U tunnel (if already available), etc.) either in E1 context setup or E1 configuration update procedures towards other CU-CP(s) that has not started the same broadcast service. As an example, some CU-CP(s) may not establish a broadcast setup yet but already have an active E1 connection with the shared CU-UP 110. As another example, new CU-CP(s) that may create a link in the future with the CU-UP 110.

As shown, the CU-UP 110 transmits 406 all the collected information with the CU-CP 122 that has not established broadcast setup yet, but already established E1 interface. For example, the collected information may be carried in a Bearer Context Modification Request message (e.g., E1AP Bearer Context Modification Request). Additionally, the CU-UP 110 may also transmit an explicit indication about the shared broadcast service, such as, the associated session ID (e.g., SSM info). As an example, the following IEs may be exchanged, a list of TMGIs, a list of tunnel IDs, ID information of the selected tunnel, and the SSM. As another example, a mapping list of TMGIs to tunnel IDs and the SSM may be exchanged.

The CU-UP 110 may share additional information with the CU-CP 122 that has not established broadcast setup yet, but already established E1 interface. In some example embodiments, the tunnel ID of the CU-CPs that use a particular NG-U tunnel for a TMGI may also be exchanged in E1 setup/E1 configuration update message. This may indeed be useful for selection of the same NG-U tunnel by the neighbor gNBs for achieving service continuity during mobility.

Alternatively, in some other embodiments, instead of transmitting all the details (e.g., TMGIs, tunnel IDs, established/preferred tunnels, SSM, etc.), the CU-UP 110 may simply transmit, along with the list of TMGIs, established/preferred tunnels and the indicator indicating that the NG-U tunnel is shared among PLMNs for the shared broadcast service. For the CU-CP 126 that has not established E1 interface yet, it may transmit 408 a E1 Setup or Modification Request message to the CU-UP 110. Upon receiving the E1 Setup Request message, the CU-CP 110 may transmit 410 a E1 Setup or Modification Response along with the above IEs, such as, {a list of TMGIs, a list of tunnel IDs, ID information of the selected tunnel, the SSM}, or {a mapping list of TMGIs to tunnel IDs, the SSM}, or {a list of TMGIs, ID information of the selected tunnel, the indicator indicating that the NG-U tunnel and the broadcast service are shared}.

Alternatively, the CU-UP 110 may proactively transmit 412 a E1 Setup or Modification Request message along with the above IEs.

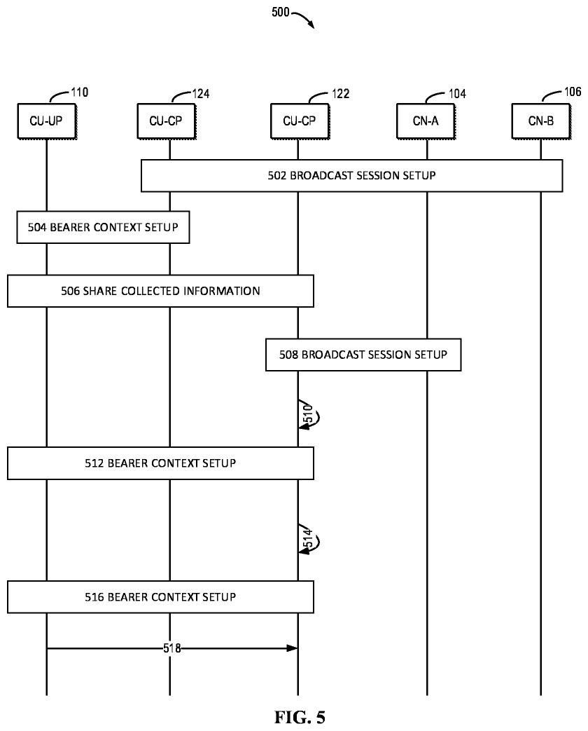

Reference is now made to FIG. 5, which shows a signaling chart 500 for communication according to some example embodiments of the present disclosure. As shown in FIG. 5, the process 500 involves CU-UP 110, CU-CP 122, CU-CP 124, CN-A 104 and CN-B 106. For the purpose of discussion, reference is made to FIG. 1 to describe the signaling chart 500.

In the process 500, the CN-A 104 and CN-B 106 have setup 502 the broadcast session with CU-CP 124 respectively. The CU-UP 110 has performed 504 the bearer context setup or modification with CU-CP 124. In addition, the CU-UP 110 shares 506 all the collected information (e.g., broadcast service and tunnel configuration information) with the CU-CPs that have not established broadcast setup yet, for example, CU-CP 122.

Afterwards, some of these CU-CPs may receive a Broadcast Session Setup Request from its serving CN. For example, CU-CP 122 receives 508 the Broadcast Session Setup Request from CN-A 104. In this case, CU-CP 122 may understand that the same broadcast service is already available through an NG-U tunnel (i.e., NG-U TNL-B) for the CU-UP 110, but CU-CP 122 does not serve CN-B 106 for which the tunnel is established.

The CU-CP 122 may then decide whether to accept to use the already established tunnel that is shared with the non-serving CN-B 106. The decision may be based on operator configuration at the CU-CP and/or based on neighbor CU-CP information received in process 400.

In some example embodiments, the CU-CP 122 determines 510 to accept the NG-U TNL-B to be used for the broadcast service, even if the tunnel is not with its serving CN-A 104. For example, the CU-UP 110 may indicate to CU-CP 122 that for the same broadcast service, it has already established tunnel NG-U TNL-B with CN-B 106. CU-CP 122 accepts to use the tunnel NG-U TNL-B with the non-registered CN-B 106 for its broadcast service. The CU-CP 122 may then transmit 512 a Bearer Context Setup or Modification Request message to the CU-UP 110 for indicating the preference to use the already existing tunnel NG-U TNL-B, although that CN-B 106/PLMN B is not served by the CU-CP 122.

Additionally, or alternatively, the CU-CP 122 may also include an indicator of whether sharing a tunnel with at least one other CN is allowed (e.g., OPEN-or-Not-indicator (OPEN/Not-OPEN/Conditional-OPEN)).

Otherwise, if the CU-CP 122 determines 514 not to accept to use the existing tunnel NG-U TNL-B with the non-serving CN-B 106. In this case, the CU-CP 122 may prefer to set up a new tunnel with its serving CN-A 104. The CU-CP 122 may then transmit 516 a Bearer Context Setup or Modification Request message to the CU-UP 110 for indicating the tunnel preference, i.e., not to use the already existing tunnel and setup a new tunnel for CN-A 104.

As a result, the CP-UP 110 may share 518 the updated MBS configuration context, for example, two NG-U Tunnel IDs with two PLMNs, with all the associated CU-CPs, as step 506.

According to the example embodiments of the present disclosure, there is provided a coordination mechanism for RAN nodes. With the coordination mechanism, the shared CU-CP can optimize the use of NG-U tunnels towards various CNs and/or PLMNs by considering tunnel preference of respective CU-CPs. With the tunnel preference, the shared CU-UP is aware of whether an existing tunnel can be reused for communicating the same broadcast, or separate, redundant tunnel is required to be created. In this way, the coordination operations can be realized in RAN nodes. In addition, the resource efficiency and network performance for MBS services can be improved.

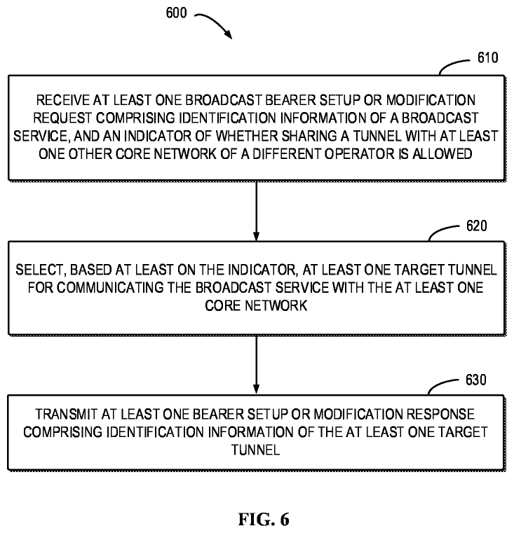

FIG. 6 shows a flowchart of an example method 600 implemented at a first network device in accordance with some example embodiments of the present disclosure. For example, the first network device may be implemented by a CU-UP entity in a RAN node (e.g., gNB), such as, the CU-UP 110 shown in FIG. 1. For the purpose of discussion, the method 600 will be described from the perspective of the CU-UP 110 in FIG. 1.

At block 610, the first network device receives, from at least one second network device managing control plane data for at least one core network (e.g. at least a first core network) of a first operator, at least one broadcast bearer setup or modification request comprising identification information of a broadcast service, and an indicator of whether sharing a tunnel associated with the broadcast service with at least one other core network of a different operator is allowed.

At block 620, the first network device selects or creates, based at least on the indicator, at least one target tunnel for communicating the broadcast service with the at least one core network.

At block 630, the first network device transmits, to the at least one second network device, at least one broadcast bearer setup or modification response comprising identification information of the at least one target tunnel.

In some example embodiments, the identification information of the broadcast service comprises at least one of the following:
an identifier of the broadcast service specific to a corresponding core network of the first operator, or
an identifier of the broadcast service common with at least two core networks.

In some example embodiments, the indicator is set to one of the following:
a first value indicating that the second network device allows sharing a tunnel with at least one core network of a different operator,
a second value indicating that the second network device does not allow sharing a tunnel with the at least one other core network of a different operator, or
a third value indicating that the second network device conditionally allows sharing a tunnel with the at least one other core network of another operator, wherein the second network device allows sharing the tunnel with the at least one other core network of a different operator only if the target tunnel with the at least one core network of the first operator is failed.

In some example embodiments, the at least one second network device comprises a second network device serving a plurality of core networks, and for each of the plurality of core networks, the at least one broadcast bearer setup or modification request from the second network device comprises a temporary mobile group identity and the indicator, and wherein the first received bearer setup or modification request from the second network device further comprises tunnel preference information of a first core network, and at least one subsequent broadcast bearer setup or modification request from the second network device comprises one of the following:
tunnel preference information of the first core network which indicates a reuse of the target tunnel of the first core network,
tunnel preference information of a second core network which indicates to create a target tunnel for the second core network, or
lack of tunnel preference information which indicates a reuse of an existing target tunnel.

In some example embodiments, the at least one second network device comprises a second network device serving a core network of a single operator.

In some example embodiments, the first network device is caused to: in accordance with a determination that no tunnel preference information or a different tunnel preference information is received in the at least one broadcast bearer setup or modification request, create the target tunnel with a first core network associated with the second network device.

In some example embodiments, the first network device is caused to: receive, from a third network device managing control plane data for at least a third core network, a broadcast bearer setup or modification request comprising identification information of the broadcast service, tunnel preference information of the third core network, and the indicator; and in accordance with a determination that the tunnel preference information of the third core network is not satisfied by any of the at least one target tunnel, create an additional target tunnel with the third core network.

In some example embodiments, the at least one broadcast bearer setup or modification response further comprises identification information of at least one fallback tunnel.

In some example embodiments, the first network device is caused to: in accordance with a determination that a failure occurs in the at least one target tunnel, and the indicator associated with the second network device indicates that sharing the tunnel with at least one other core network of another operator is allowed, select a new target tunnel from the at least one fallback tunnel; and transmit, to the second network device, a configuration update message comprising identification information of the new target tunnel.

In some example embodiments, the first network device is caused to: in accordance with a determination that a failure occurs in the at least one target, and the indicator associated with the second network device indicates not to share the tunnel with at least one other core network of another operator, create an additional target tunnel with a core network served by the second network device; and transmit, to the second network device, a configuration update message comprising identification information of the additional target tunnel.

In some example embodiments, the first network device is caused to: determine that the broadcast service is not started on a fourth network device managing control plane data for at least a fourth core network; and transmit, to the fourth network device, a configuration associated with the at least one target tunnel.

In some example embodiments, the configuration comprises one of the following:
a list of temporary mobile group identities (TMGIs), a list of identification information of the at least one target tunnel, identification information of a tunnel selected for communicating the broadcast service, and an identifier of the broadcast service common with at least two core networks of different operators,
a mapping list of the TMGIs to the identification information of the at least one target tunnel, and the identifier of the broadcast service common with at least two core networks,
the list of TMGIs, the identification information of the tunnel selected for communicating the broadcast service, and an indication of the selected tunnel being shared among a plurality of core networks for the broadcast service.

In some example embodiments, the first network device is caused to: receive, from the fourth network device, a broadcast bearer setup or modification request comprising tunnel preference information of one of the at least one selected tunnel.

In some example embodiments, the broadcast bearer setup or modification request further comprises an indication of whether sharing a tunnel with at least one other core network of a different operator is allowed.

In some example embodiments, the first network device is caused to: receive, from the fourth network device, a broadcast bearer setup or modification request comprising tunnel preference information indicating that none of the at least one target tunnel to be used for the broadcast service; and transmit, to the fourth network device, a configuration of an updated broadcast service context.

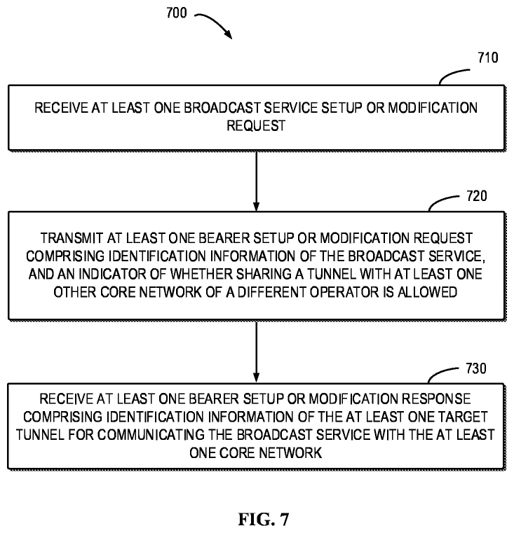

FIG. 7 shows a flowchart of an example method 700 implemented at a second network device in accordance with some example embodiments of the present disclosure. For example, the second network device may be implemented by a CU-CP entity in a RAN node (e.g., gNB), such as, the CU-CP 122, or the CU-CP 124 shown in FIG. 1. For the purpose of discussion, the method 700 will be described from the perspective of the CU-CP 122 in FIG. 1.

At block 710, the second network device receives, from at least one entity of at least one core network, at least one broadcast service setup or modification request for a broadcast service.

At block 720, the second network device transmits, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network.

At block 730, the second network device receives, from the first network device, at least one bearer setup or modification response comprising identification information of the at least one target tunnel for communicating the broadcast service with the at least one core network.

In some example embodiments, the identification information of the broadcast service comprises at least one of the following:
an identifier of the broadcast service specific to a corresponding core network of the first operator, or
an identifier of the broadcast service common with at least two core networks of different operators.

In some example embodiments, the indicator is set to one of the following:
a first value indicating that the second network device allows sharing a tunnel with at least one other core network of a different operator,
a second value indicating that the second network device does not allow sharing a tunnel with the at least one other core network of a different operator, or
a third value indicating that the second network device allows conditionally sharing of a tunnel with the at least one other core network of different operator, wherein the sharing is allowed with the at least one other core network of different operator only if the target tunnel with the at least one core network of the first operator is failed.

In some example embodiments, the second network device serves a plurality of core networks of different operators, and wherein the second network device is caused to: for each of the plurality of core networks, after receiving the broadcast service setup or modification request, transmit a corresponding broadcast bearer setup or modification request to the first network device, wherein the first transmitted broadcast bearer setup or modification request comprises tunnel preference information of a first core network, and at least one subsequent broadcast bearer setup or modification request comprises one of the following:
tunnel preference information of the first core network which indicates a reuse of the target tunnel of the first core network,
preference information of a second core network which indicates to create a target tunnel for the second core network, or
lack of tunnel preference information which indicates a reuse of an existing target tunnel.

In some example embodiments, the second network device serves a core network of a single operator.

In some example embodiments, wherein the identification information of the at least one target tunnel comprises at least one of the following:
identification information of a shared tunnel with at least one other core network, or
identification information of a separate tunnel with a first core network that has at least one second network device serving only the first core network.

In some example embodiments, the at least one broadcast bearer setup or modification response further comprises identification information of at least one fallback tunnel.

In some example embodiments, the second network device is caused to: receive, from the first network device, a configuration update message comprising identification information of one of the at least one fallback tunnel as the selected tunnel.

In some example embodiments, the second network device is caused to: receive, from the first network device, a configuration update message comprising identification information of an additional target tunnel with a core network served by the second network device.

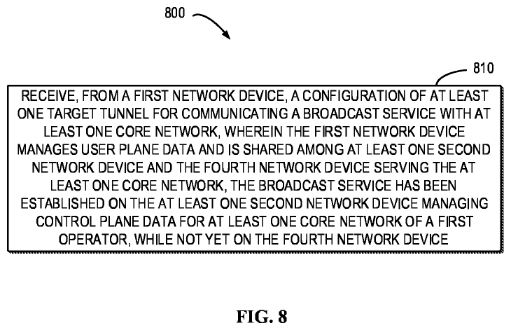

FIG. 8 shows a flowchart of an example method 800 implemented at a fourth network device in accordance with some example embodiments of the present disclosure. For example, the fourth network device may be implemented by a CU-CP entity in a RAN node (e.g., gNB), such as, the CU-CP 126 shown in FIG. 1. For the purpose of discussion, the method 800 will be described from the perspective of the CU-CP 126 in FIG. 1.

At block 810, the fourth network device receives, from a first network device, a configuration of at least one target tunnel for communicating a broadcast service with at least one core network, wherein the first network device manages user plane data and is shared among at least one second network device and the fourth network device serving the at least one core network, the broadcast service has been established on the at least one second network device managing control plane data for at least one core network of a first operator, while not yet on the fourth network device.

In some example embodiments, the configuration comprises one of the following:
a list of TMGIs, a list of identification information of the at least one target tunnel, identification information of a tunnel selected for communicating the broadcast service, and an identifier of the broadcast service common with at least two core networks of different operators,
a mapping list of the TMGIs to the identification information of the at least one target tunnel, and the identifier of the broadcast service common with at least two core networks,
the list of TMGIs, the identification information of the tunnel selected for communicating the broadcast service, and an indication of the selected tunnel being shared among a plurality of core networks for the broadcast service.

In some example embodiments, the fourth network device may be further caused to: transmit, to the first network device, a bearer setup or modification request comprising tunnel preference information of one of the at least one target tunnel.

In some example embodiments, the bearer setup or modification request may further comprise an indication of whether sharing the tunnel with at least one other core network of a different operator is allowed.

In some example embodiments, the fourth network device may be caused to: transmit, to the first network device, a bearer setup or modification request comprising tunnel preference information indicating of none of the at least one target tunnel to be used for the broadcast service; and receive, from the first network device, a configuration of an updated broadcast service context.

In some example embodiments, a first apparatus capable of performing any of the method 600 (for example, the CU-UP 110 in FIG. 1) may comprise means for performing the respective operations of the method 600. The means may be implemented in any suitable form. For example, the means may be implemented in a circuitry or software module. The first apparatus may be implemented as or included in the CU-UP 110 in FIG. 1.

In some example embodiments, the first apparatus comprises: means for receiving, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed; means for selecting or creating, based at least on the indicator, at least one target tunnel for communicating the broadcast service with the at least one core network; and means for transmitting, to the at least one second network device, at least one bearer setup or modification response comprising identification information of the at least one target tunnel.

In some example embodiments, the identification information of the broadcast service comprises at least one of the following:
an identifier of the broadcast service specific to a corresponding core network of the first operator, or
an identifier of the broadcast service common with at least two core networks.

In some example embodiments, the indicator is set to one of the following:
a first value indicating that the second network device allows sharing a tunnel with at least one core network of a different operator,
a second value indicating that the second network device does not allow sharing a tunnel with the at least one other core network of a different operator, or
a third value indicating that the second network device conditionally allows sharing a tunnel with the at least one other core network of another operator, wherein the second network device allows sharing the tunnel with the at least one other core network of a different operator only if the target tunnel with the at least one core network of the first operator is failed.

In some example embodiments, the at least one second network device comprises a second network device serving a plurality of core networks, and for each of the plurality of core networks, the at least one broadcast bearer setup or modification request from the second network device comprises a temporary mobile group identity and the indicator, and wherein the first received bearer setup or modification request from the second network device further comprises tunnel preference information of a first core network, and at least one subsequent broadcast bearer setup or modification request from the second network device comprises one of the following:
tunnel preference information of the first core network which indicates a reuse of the target tunnel of the first core network,
tunnel preference information of a second core network which indicates to create a target tunnel for the second core network, or
lack of tunnel preference information which indicates a reuse of an existing target tunnel.

In some example embodiments, the at least one second network device comprises a second network device serving a core network of a single operator.

In some example embodiments, the first apparatus may further comprise: means for in accordance with a determination that no tunnel preference information or a different tunnel preference information is received in the at least one broadcast bearer setup or modification request, creating the target tunnel with a first core network associated with the second network device.

In some example embodiments, the first apparatus may further comprise: means for receiving, from a third network device managing control plane data for at least a third core network, a broadcast bearer setup or modification request comprising identification information of the broadcast service, tunnel preference information of the third core network, and the indicator; and means for in accordance with a determination that the tunnel preference information of the third core network is not satisfied by any of the at least one target tunnel, creating an additional target tunnel with the third core network.

In some example embodiments, the at least one broadcast bearer setup or modification response further comprises identification information of at least one fallback tunnel.

In some example embodiments, the first apparatus may further comprise: means for in accordance with a determination that a failure occurs in the at least one target tunnel, and the indicator associated with the second network device indicates that sharing the tunnel with at least one other core network of another operator is allowed, selecting a new target tunnel from the at least one fallback tunnel; and means for transmitting, to the second network device, a configuration update message comprising identification information of the new target tunnel.

In some example embodiments, the first apparatus may further comprise: means for in accordance with a determination that a failure occurs in the at least one target, and the indicator associated with the second network device indicates not to share the tunnel with at least one other core network of another operator, creating an additional target tunnel with a core network served by the second network device; and means for transmitting, to the second network device, a configuration update message comprising identification information of the additional target tunnel).

In some example embodiments, the first apparatus may further comprise: means for determining that the broadcast service is not started on a fourth network device managing control plane data for at least a fourth core network; and means for transmitting, to the fourth network device, a configuration associated with the at least one target tunnel.

In some example embodiments, the configuration comprises one of the following:
a list of temporary mobile group identities (TMGIs), a list of identification information of the at least one target tunnel, identification information of a tunnel selected for communicating the broadcast service, and an identifier of the broadcast service common with at least two core networks of different operators,
a mapping list of the TMGIs to the identification information of the at least one target tunnel, and the identifier of the broadcast service common with at least two core networks,
the list of TMGIs, the identification information of the tunnel selected for communicating the broadcast service, and an indication of the selected tunnel being shared among a plurality of core networks for the broadcast service.

In some example embodiments, the first apparatus may further comprise: means for receiving, from the fourth network device, a broadcast bearer setup or modification request comprising tunnel preference information of one of the at least one selected tunnel. In some example embodiments, the broadcast bearer setup or modification request further comprises an indication of whether sharing a tunnel with at least one other core network of a different operator is allowed.

In some example embodiments, the first apparatus may further comprise: means for receiving, from the fourth network device, a broadcast bearer setup or modification request comprising tunnel preference information indicating that none of the at least one target tunnel to be used for the broadcast service; and means for transmitting, to the fourth network device, a configuration of an updated broadcast service context.

In some example embodiments, a second apparatus capable of performing any of the method 700 (for example, the CU-CP 124 in FIG. 1) may comprise means for performing the respective operations of the method 700. The means may be implemented in any suitable form. For example, the means may be implemented in a circuitry or software module. The second apparatus may be implemented as or included in the CU-CP 124 in FIG. 1.

In some example embodiments, the second apparatus comprises means for receiving, from at least one entity of at least one core network, at least one broadcast service setup or modification request for a broadcast service; means for transmitting, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network; and means for receiving, from the first network device, at least one bearer setup or modification response comprising identification information of the at least one target tunnel for communicating the broadcast service with the at least one core network.

In some example embodiments, the identification information of the broadcast service comprises at least one of the following:
an identifier of the broadcast service specific to a corresponding core network of the first operator, or
an identifier of the broadcast service common with at least two core networks of different operator.

In some example embodiments, the indicator is set to one of the following:
a first value indicating that the second network device allows sharing a tunnel with at least one other core network of a different operator,
a second value indicating that the second network device does not allow sharing a tunnel with the at least one other core network of a different operator, or
a third value indicating that the second network device allows conditionally sharing of a tunnel with the at least one other core network of different operator, wherein the sharing is allowed with the at least one other core network of different operator only if the target tunnel with the at least one core network of the first operator is failed.

In some example embodiments, the second apparatus serves a plurality of core networks, and the second apparatus further comprise means for, for each of the plurality of core networks, after receiving the broadcast service setup or modification request, transmitting a corresponding broadcast bearer setup or modification request to the first network device, wherein the first transmitted broadcast bearer setup or modification request comprises tunnel preference information of a first core network, and at least one subsequent broadcast bearer setup or modification request comprises one of the following:
tunnel preference information of the first core network which indicates a reuse of the target tunnel of the first core network,
preference information of a second core network which indicates to create a target tunnel for the second core network, or
lack of tunnel preference information which indicates a reuse of an existing target tunnel.

In some example embodiments, the second network device serves a core network of a single operator.

In some example embodiments, the identification information of the at least one target tunnel comprises at least one of the following:
identification information of a shared tunnel with at least one other core network, or
identification information of a separate tunnel with a first core network that has at least one second network device serving only the first core network.

In some example embodiments, the at least one broadcast bearer setup or modification response further comprises identification information of at least one fallback tunnel.

In some example embodiments, the second apparatus further comprises means for receiving, from the first network device, a configuration update message comprising identification information of one of the at least one fallback tunnel as the selected tunnel.

In some example embodiments, the second apparatus further comprises means for receiving, from the first network device, a configuration update message comprising identification information of an additional target tunnel with a core network served by the second network device.

In some example embodiments, a fourth apparatus capable of performing any of the method 800 (for example, the CU-CP 126 in FIG. 1) may comprise means for performing the respective operations of the method 800. The means may be implemented in any suitable form. For example, the means may be implemented in a circuitry or software module. The fourth apparatus may be implemented as or included in the CU-CP 126 in FIG. 1.

In some example embodiments, the fourth apparatus comprises means for receiving, from a first network device, a configuration of at least one target tunnel for communicating a broadcast service with at least one core network, wherein the first network device manages user plane data and is shared among at least one second network device and the fourth network device serving the at least one core network, the broadcast service has been established on the at least one second network device managing control plane data for at least one core network of a first operator, while not yet on the fourth network device.

In some example embodiments, the configuration comprises one of the following:
a list of TMGIs, a list of identification information of the at least one target tunnel, identification information of a tunnel selected for communicating the broadcast service, and an identifier of the broadcast service common with at least two core networks of different operators,
a mapping list of the TMGIs to the identification information of the at least one target tunnel, and the identifier of the broadcast service common with at least two core networks,
the list of TMGIs, the identification information of the tunnel selected for communicating the broadcast service, and an indication of the selected tunnel being shared among a plurality of core networks for the broadcast service.

In some example embodiments, the fourth apparatus further comprises: means for transmitting, to the first network device, a bearer setup or modification request comprising tunnel preference information of one of the at least one target tunnel.

In some example embodiments, the bearer setup or modification request may further comprise an indication of whether sharing the tunnel with at least one other core network of a different operator is allowed.

In some example embodiments, the fourth apparatus further comprises: means for transmitting, to the first network device, a bearer setup or modification request comprising tunnel preference information indicating of none of the at least one target tunnel to be used for the broadcast service; and receive, from the first network device, a configuration of an updated broadcast service context.

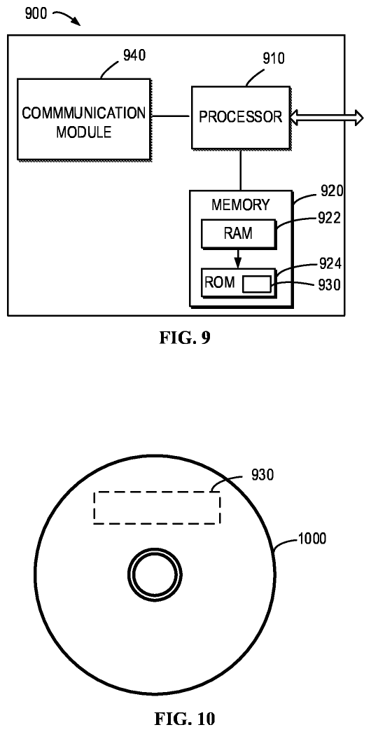

FIG. 9 is a simplified block diagram of a device 900 that is suitable for implementing example embodiments of the present disclosure. The device 900 may be provided to implement a communication device, for example, the first network device 110, the second network device 120, the third network device 130, or the fourth network device 140 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 3 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server. In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first network device comprising:
at least one processor; and
at least one memory storing instructions that, when executed by the at least one processor, cause the first network device managing user plane data at least to:
receive, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed;
select or create, based at least on the indicator, at least one target tunnel for communicating the broadcast service with the at least one core network; and
transmit, to the at least one second network device, at least one broadcast bearer setup or modification response comprising identification information of the at least one target tunnel.

2. The first network device of claim 1, wherein the identification information of the broadcast service comprises at least one of the following:
an identifier of the broadcast service specific to a corresponding core network of the first operator, or
an identifier of the broadcast service common with at least two core networks.

3. The first network device of claim wherein the indicator is set to one of the following:
a first value indicating that the second network device allows sharing a tunnel with at least one core network of a different operator,
a second value indicating that the second network device does not allow sharing a tunnel with the at least one other core network of a different operator, or
a third value indicating that the second network device conditionally allows sharing a tunnel with the at least one other core network of another operator, wherein the second network device allows sharing the tunnel with the at least one other core network of a different operator only if the at least one target tunnel with the at least one core network of the first operator is failed.

4.-5. (canceled)

6. The first network device of claim 1, wherein the first network device is caused to:
in accordance with a determination that no tunnel preference information is received in the at least one broadcast bearer setup or modification request, create the target tunnel with a first core network associated with the second network device.

7. The first network device of claim 1, the first network device is caused to:
receive, from a third network device managing control plane data for at least a third core network, a broadcast bearer setup or modification request comprising identification information of the broadcast service, tunnel preference information of the third core network, and the indicator; and
in accordance with a determination that the tunnel preference information of the third core network is not satisfied by any of the at least one target tunnel, create an additional target tunnel with the third core network.

8. The first network device of claim 1, wherein the at least one broadcast bearer setup or modification response further comprises identification information of at least one fallback tunnel.

9. The first network device of claim 8, wherein the first network device is caused to:
in accordance with a determination that a failure occurs in the at least one target tunnel, and the indicator associated with the second network device indicates that sharing the tunnel with at least one other core network of another operator is allowed, select a new target tunnel from the at least one fallback tunnel; and
transmit, to the second network device, a configuration update message comprising identification information of the new target tunnel.

10. The first network device of claim 8, wherein the first network device is caused to:
in accordance with a determination that a failure occurs in the at least one target tunnel, and the indicator associated with the second network device indicates not to share the tunnel with at least one other core network of another operator, create an additional target tunnel with a core network served by the second network device; and
transmit, to the second network device, a configuration update message comprising identification information of the additional target tunnel.

11. The first network device of claim 1, wherein the first network device is caused to:
determine that the broadcast service is not started on a fourth network device managing control plane data for at least a fourth core network; and
transmit, to the fourth network device, a configuration associated with the at least one target tunnel.

12. The first network device of claim 11, wherein the configuration comprises one of the following:
a list of temporary mobile group identities (TMGIs), a list of identification information of the at least one target tunnel, identification information of a tunnel selected for communicating the broadcast service, and an identifier of the broadcast service common with at least two core networks of different operators, or
a mapping list of the TMGIs to the identification information of the at least one target tunnel, and the identifier of the broadcast service common with at least two core networks, or
the list of TMGIs, the identification information of the target tunnel selected for communicating the broadcast service, and an indication of the target tunnel being shared among a plurality of core networks for the broadcast service.

13. The first network device of claim 11, wherein the first network device is caused to:
receive, from the fourth network device, a broadcast bearer setup or modification request comprising tunnel preference information of one of the at least one target tunnel.

14. The first network device of claim 13, wherein the broadcast bearer setup or modification request further comprises an indication of whether sharing a tunnel with at least one other core network of a different operator is allowed.

15. The first network device of claim 11, or wherein the first network device is caused to:
receive, from the fourth network device, a broadcast bearer setup or modification request comprising tunnel preference information indicating that none of the at least one target tunnel to be used for the broadcast service; and
transmit, to the fourth network device, a configuration of an updated broadcast service context.

16. A second network device comprising:
at least one processor; and
at least one memory storing instructions that, when executed by the at least one processor, cause the second network device managing control plane data for at least one core network of a first operator at least to:
receive, from at least one entity of at least one core network, at least one broadcast service setup or modification request for a broadcast service;
transmit, to a first network device, at least one broadcast bearer setup or modification request comprising identification information of the broadcast service, and an indicator of whether sharing a tunnel associated with the broadcast service with at least one other core network of a different operator is allowed, wherein the first network device manages user plane data and is shared among a plurality of second network devices serving at least one core network; and
receive, from the first network device, at least one bearer setup or modification response comprising identification information of the at least one target tunnel for communicating the broadcast service with the at least one core network.

17. The second network device of claim 16, wherein the identification information of the broadcast service comprises at least one of the following:
an identifier of the broadcast service specific to a corresponding core network of the first operator, or
an identifier of the broadcast service common with at least two core networks of different operators.

18. The second network device of claim 16, wherein the indicator is set to one of the following:
a first value indicating that the second network device allows sharing a tunnel with at least one other core network of a different operator,
a second value indicating that the second network device does not allow sharing a tunnel with the at least one other core network of a different operator, or
a third value indicating that the second network device allows conditionally sharing of a tunnel with the at least one other core network of different operator, wherein the sharing is allowed with the at least one other core network of different operator only if the at least one target tunnel with the at least one core network of the first operator is failed.

19. The second network device of claim 16, wherein the second network device serves a plurality of core networks of different operators, and
wherein the second network device is caused to:
for each of the plurality of core networks, after receiving the broadcast service setup or modification request, transmit a corresponding broadcast bearer setup or modification request to the first network device,
wherein the first transmitted broadcast bearer setup or modification request comprises tunnel preference information of a first core network, and at least one subsequent broadcast bearer setup or modification request comprises one of the following:
tunnel preference information of the first core network which indicates a reuse of the target tunnel of the first core network,
preference information of a second core network which indicates to create a target tunnel for the second core network, or
lack of tunnel preference information which indicates a reuse of an existing target tunnel.

20. The second network device of claim 16, wherein the second network device serves a core network of a single operator.

21. The second network device of claim 16, wherein the identification information of the at least one target tunnel comprises at least one of the following:
identification information of a shared tunnel with at least one other core network, or
identification information of a separate tunnel with a first core network that has at least one second network device serving only the first core network.

22.-24. (canceled)

25. A method for a first network device managing user plane data, the method comprising:
receiving, from at least one second network device managing control plane data for at least one core network of a first operator, at least one broadcast bearer setup or modification request comprising identification information of a broadcast service, and an indicator of whether sharing a tunnel associated with the broadcast service with at least one other core network of a different operator is allowed;
selecting or creating, based at least on the indicator, at least one target tunnel for communicating the broadcast service with the at least one core network; and
transmitting, to the at least one second network device, at least one bearer setup or modification response comprising identification information of the at least one target tunnel.

26.-29. (canceled)
